(19) United States
(12) Patent Application Publication
(10) Pub. No.: US 2018/0247356 A1
(43) Pub. Date: Aug. 30, 2018

(54) Computer implemented platform for the creation of a virtual product

(71) Applicant: Finity Technology Limited, London (GB)

(72) Inventor: Rodger Bryan Thompson, London (GB)

(21) Appl. No.: 15/552,456

(22) PCT Filed: Feb. 25, 2016
(86) PCT No.: PCT/IB2016/051025

§ 371 Date: Aug. 21, 2017

(30) Foreign Application Priority Data
Feb. 26, 2015 (IT) VE2015A000008

(51) Int. Cl. G06Q 30/06; G06F 17/30; G06N 5/02

(52) U.S. Cl. CPC G06Q 30/0621; G06N 5/022; G06F 17/30964

(57) ABSTRACT

A computer implemented platform to create and display a virtual product to be manufactured and/or assembled includes: a database storing variations of components that define variants of the virtual product and data on mechanical coupling of all component variations; a hardware infrastructure storing and running artificial intelligence that selects, suggests, and displays optimal variations among a plurality of variations stored in the database, and a software module creating the variable virtual product, wherein, starting from an initial version, the user can interactively and cyclically choose one or more of the variations selected and suggested by the artificial intelligence and displayed on a graphical user interface, until reaching an acceptable final version to be realized by the manufacturing and/or assembly process; and an interface for interacting with, monitoring and controlling the artificial intelligence and software module and that includes and electronic visual display and input pointing device for control and management.

This invention relates to a computer implemented platform for the creation and display of a variable virtual product that is then intended to be realized as a physical product by an associated manufacturing and/or assembly process.

Hereafter, “virtual product” shall refer to a computer-generated product that is created in a three dimensional form from a computer process and can be displayed on the screen of any computer (laptop, tablet, smartphone, etc.), or via other digital display methods. In particular, the “virtual product” corresponds to an actual real and manufacturable product, but one that may not yet have been physically made. Additionally, “physical product” will mean a product that is real, concrete and tangible.

There are known e-commerce platforms, i.e. the sites or web portals specialized in the sale of goods and/or services via the Internet, such as E-bay, Amazon, etc. that allow the user to choose the product to be purchased from a number of standard and predefined product options, without allowing the user to create new products or to customize or modify existing products.

Furthermore, in the case of online purchases of products or clothing accessories, the user does not have the opportunity to try them on virtually or wear them physically in order to make an assessment for themselves regarding fit or style compatibility. Therefore the purchase is based on a standard ‘as-is’ basis.

In an attempt to overcome this limitation, virtual fitting solutions are used, in which an image of the user is acquired and on which virtual products (such as garments or accessories) can be viewed. In particular, for these known solutions (see for example www.ditto.com and www.glasses.com/virtual-try-on), the acquisition of the virtual image of the face or other physical characteristics of the user is employed exclusively to perform a virtual test of the selected product and not to enable the user to modify components to reach a more appropriate variant.

Also known are the sites and applications through which the user can customize a virtual version of a specific product, which can be displayed in real-time and interactively on a computer monitor (or other digital display means).

In this regard, some systems allow the user to customize the product by changing the color of some of its parts (see e.g., www.nikeid.com for shoes or www.oakley.com/en/custom for eyewear), or by choosing to print on the product words/letters or images (see e.g. www.adidas.co.uk/mzixful). Additionally, there are other known systems that offer the possibility to customize the product by starting from a standard model, and then by making minor changes, for example regarding the color or material, or by modifying only certain well-defined areas of the product, as in the case of www.burberry.com/bespoke/. This allows the user to customize a coat by varying the type of buttons, sleeves, belt, etc.

In essence, all of these known solutions do not offer the user an adequate support in the creation and/or customization of the virtual prototype of the product. They offer limited interactivity and control over the design of the product and they do not integrate personal design or style intelligence in order to create a product that is more aligned with a user's preferences. These known solutions also do not integrate advanced product visualization which permits the user to easily view product variants in detail or to see these product variants, in a virtual form, on themselves or other people in order to evaluate relevant fit and style. They also offer the user a limited customization experience and personal design input.

There are also known systems that catalog customer buying preferences in order to provide them with suggestions for alternative or future purchases. In particular, these systems use two main types of approach: one type—known as “collaborative filtering”—is based on past behavior of the user or of other similar users (for example, Amazon.com's or Target's recommendations based on what others have bought or viewed). The other—known as “content based filtering”—is based on the content or the characteristics of the product itself (for example, the music service “Pandora” will recommend songs based on the intrinsic characteristics and properties, as previously classified by musicians, of those songs a customer likes. At present, however, this second approach is primarily used for digital media products (for example, music or movies).

Moreover, to date, both of the above approaches are used to suggest products to purchase, and not to support the user during a customization or creation process for a physical product. These approaches are not connected to a real-time visualization system that permits the immediate visualization of different versions/options of the product (they present different standard models) as a real-time, interactive virtual product, which can be used for evaluation and feedback by the user. Nor do they connect to an on demand manufacturing process where the computer-generated product can be created.

Furthermore, these known preference and intelligence solutions fail to operate at the product component level as they look to recommend the next product, but do not permit better understanding of how an alternative component or constructions/variants fit, alter and/or improve) on the currently viewed product. Moreover, considering that each user has unique style preferences and physical features, the existing systems do not adequately support a better understanding of the individual's features and preferences and then they do not suitably match them with the component level preferences of the product.

Object of the invention is to provide a computer-implemented platform for the creation of a virtual product to be realized as a physical product by an associated manufacturing process, which will overcome the limitations and drawbacks of the above conventional systems.

Another object of the invention is to create a computer-implemented platform that actively supports each user, providing specific and personalized suggestions in the selection, creation and customization of the virtual product intended to be then physically realized.

Another object of the invention is to create a computer-implemented platform that allows the user to make an active and essential contribution during the phase of creating the design of the virtual product that is intended to then be physically realized.

Another object of the invention is to create a computer-implemented platform which allows the user a wide freedom to customize the virtual product intended to then be physically realized.

Another object of the invention is to create a computer-implemented platform which allows the user to start from a preferred version of the initial virtual product, and to modify it in order to achieve a ideal final version, which will then be realized physically.

Another object of the invention is to create a computer-implemented platform which is simple to use, easy and intuitive.

Another object of the invention is to create a computer-implemented platform, which allows the user to virtually try the product created, before proceeding to its physical realization.

Another object of the invention is to create a computer-implemented platform which allows the continuous generation of new virtual and manufacturable products from the users themselves and other collaborative partners.

These objects and others, which will become apparent from the following description, are achieved, according to the invention, by a computer implemented platform for the creation and display of a variable virtual product that is then intended to be realized as a physical product by an associated manufacturing and/or assembly process presenting the characteristics indicated in claim 1.

This invention is hereinafter further clarified in a preferred form of practical embodiment with reference to the accompanying drawings, in which:

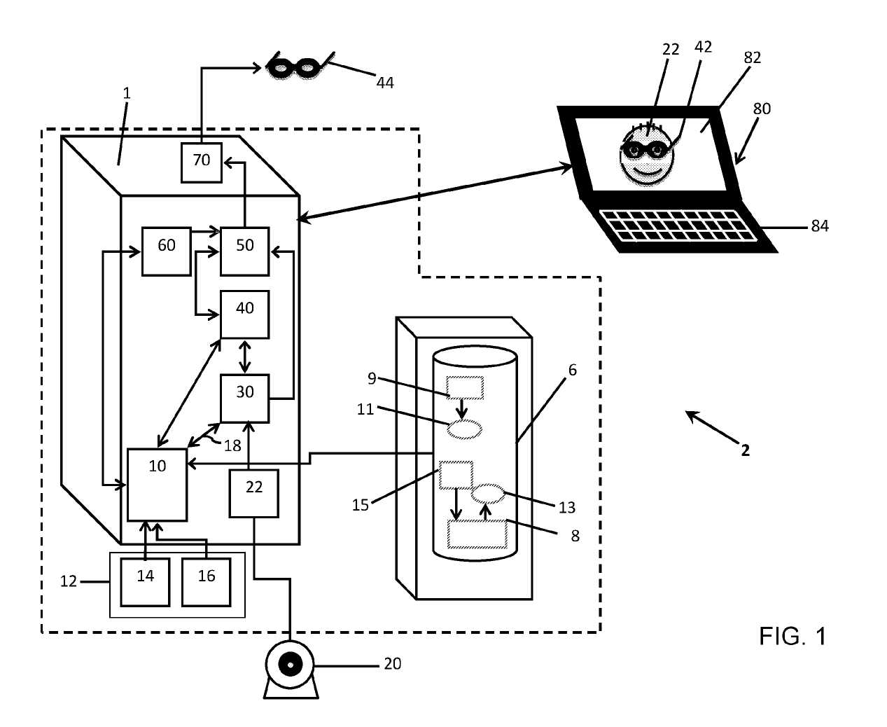

FIG. 1 shows a schematic view of the a computer-implemented platform according to the invention,

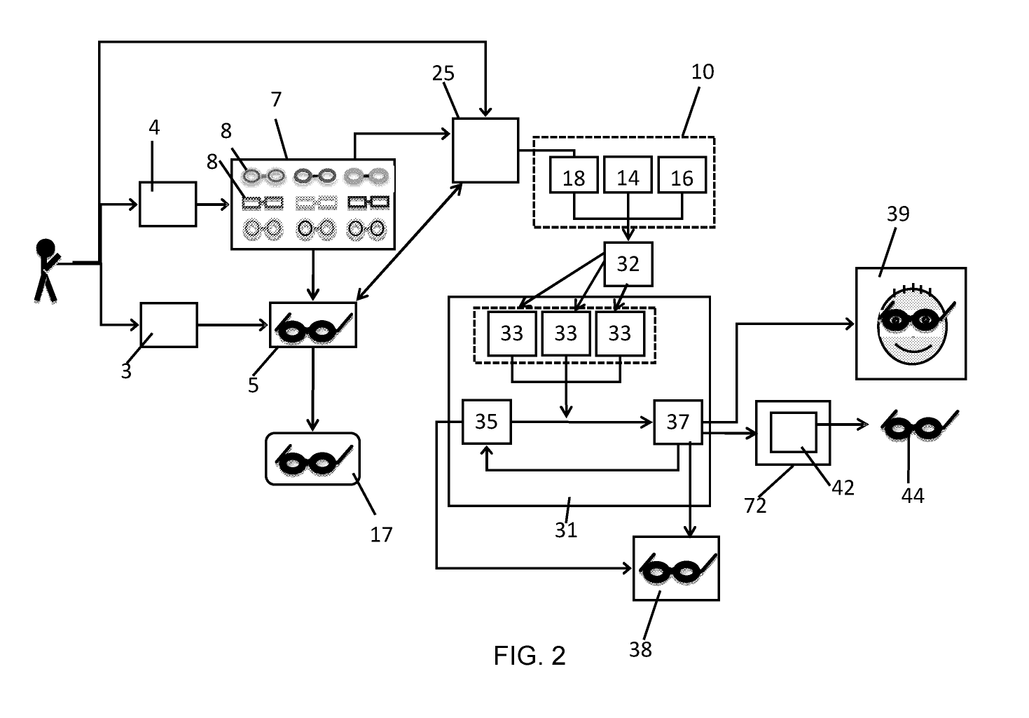

FIG. 2 shows a block diagram of the steps carried out by the user, by using the platform according to the invention, to create a virtual product to be realized as a physical product by an associated manufacturing process.

As can be seen from the figures, the computer platform 2, according to the invention, includes at least one hardware infrastructure 1 containing a number of software modules.

In particular, the hardware infrastructure 1 may include at least one PC, and/or at least one web-server and/or a plurality of networked PCs.

The platform 2 also includes at least one database 6 containing:
physical media for storing data and a processor for the processing of these (the database server),
software applications (i.e. a database management system) for the creation, manipulation, management and efficient querying of data stored in the physical media.

In the central database 6, which is preferably loaded into a “cloud server”, they are stored data 8 corresponding to all the possible types and constructive variants and limitations of the individual components which, when combined, define the product intended to be physically realized. For example, in the case in which the product to be produced is a pair of glasses, the database contains data relating to the shape, size, color, material, finishing, the surface decoration assembly of the temples, the front piece, the lenses, etc.

Through the software's database management system (DBMS), the data 8 stored in the database 6 can be invoked remotely by a server and/or from a client connected to said database via the Internet, in order to permit the processing of said data.

In particular, data 8 stored within the database 6 includes also the images, or three dimensional representation based on product data, of the various components or, preferably, include the folder addresses of the cloud server or hardware infrastructure 1 inside which said images are stored. Additionally, within the database 6 are stored data 9 relating to mechanical coupling and compatibility of the assembly of each component with the remaining components.

In particular, each component can be assembled mechanically only with a particular group of compatible components; for example, in the case in which the product to be produced is a pair of glasses, the lenses of a certain size may be inserted into different types of frames, but all with front panels of a size suitable to hold said lenses; in the same way, a certain front panel can be assembled with a plurality of temples (of different shapes and color), but all provided with the same hinge with said face piece. Based on the data of mechanical coupling 9, the components are subdivided into a plurality of groups 11—called “core design group”—each of which comprises only components that are mechanically compatible, i.e. they can be mechanically connected together.

Additionally, based on aesthetic design compatibility between all the components, these components are pre-categorized and divided into a plurality of categories 13, wherein each category comprises components sharing the same aesthetic design style; for example, a first category comprises lenses, temples and front plate of square shape design, a second category group includes lenses, temples and front panel of more rounded shape design, etc. Preferably, each category 13, in which the variations of the individual components are divided, comprises components sharing a strongly distinctive and recognizable visual core with a modularly distinctive design feature and/or as an aesthetic design feature.

Advantageously, a module may be provided, implemented by means of a suitable application programming interface (API), for updating and modifying data 8 in the database 6 and for changing the groups 11 or categories 13 into which the different types of components are divided.

Within the hardware infrastructure 1 there is an artificial intelligence software module 10 which, on the basis of a series of 12 specific information for each user, is able to select, among all the data 8 of the components stored in the database 6, those optimal for the specific user.

Advantageously, as better described in the following, the artificial intelligence software module 10 is configured to act as a personal designer and a virtual stylist for each individual user. So, it supports the consumer around product design and style choices without burdening the customer at all, by continually asking about his/her preferences, since the preference information are collected automatically based on a detailed history of shopping/web browsing behavior and/or are derived from one or more preferred products (content filtering), from physical features and/or from other know lifestyle/social characteristics.

In particular, the information 12 specific for each user and provided in input to the module of artificial intelligence software 10 includes:
information 14 relating to consumer preferences,
information 16 related to user behavior or other users while browsing the platform 2 or on other websites, and
information 18 relating to physical compatibility of a given product for a specific person and their physical characteristics.

More specifically, the information 14 relating to preferences include general issues related to a particular product (style, size, function, form, etc.), aspects related to different products, and other categories, as well as personal aspects, demographic, geographic or other information linked to social networks to which the user is connected.

In particular, the information 14 related to user preferences and/or information 16 related to user behavior can be collected in various traditional ways, such as:
suitable forms to be filled in web pages,
tracking via cookies or other traditional means for tracking the individuals' browsing histories,
input data by user through webforms
data made available from other web destinations or applications,
social media data.

Suitably, inside the artificial intelligence module 10, the abovementioned information 14 and/or 16 are connected with the aesthetic design categories 13 in which the data 8 relating to all possible variants of the individual components of the virtual product, are divided. For example, the aesthetic design category 13 comprising lenses, temples and front piece of square shape and dark in color can be associated to a profile male who likes rock music and a style of Gothic clothing; they may also be associated with a person with a square face, or with a high forehead, curly hair etc. and additionally they could be associated to a user who likes square shape, in medium dark colors.

In order to gather information 18 concerning the physical compatibility of a given product for a specific person, the platform 2 comprises means 20 for acquiring digitally the physical characteristics (e.g. the face) of the user. In particular, these means 20 comprise, for example, a camera, a webcam, a camera, a scanner and they produce as output a digital data set or image 22 of the user's physical characteristics.

Advantageously, to acquire, for example, a digital image of the face of the user, these means 20 are configured to capture appropriately more angles of the face itself, in order to allow reconstruction of a three-dimensional image 22.

Beyond said means for capturing images, the acquisition means comprise other means for obtaining the physical features of an individual user by alternative scanning methods and mold techniques (such as a smart sensing fabric).

Additionally, the platform 2 comprises a second software module 30 for the mapping of the digital image 22 relative to the physical characteristics of the user.

In particular, this module 30 receives as input the digital images 22 acquired by the method 20 and is configured to extract and estimate from that image, a series of sizes and shapes corresponding to various physical characteristics of interest; for example, in the case of digital images 22 relating to the face, the module 30 is configured to estimate the shape and the overall size of the face and/or the position of certain parts, such as nose, eyes, etc.

In particular, the software module for mapping 30 is also configured to perform the following operations:
division/classification of the physical characteristics previously estimated in a plurality of groups (for example a first group may be given by the shape of the elongated face, a second group from the shape of the face more rounded, etc.),
association of each group of facial features with one or more of aesthetic design categories 13 in which have been divided all the possible variants of the individual components of the virtual product (for example, the group relative to the elongated shape of the face is matched to the lenses of rectangular shape, while the group relative to round face shape is associated to the lenses of oval shape).

Said combinations, suitably obtained by means of software module 30, are stored within database 6. Specifically, in this way, within database 6, links (or associations) are set between data 8 that relate to the components of the products and data 15, which are also stored within the database, and which relate to the possible categorization of the various physical characteristics.

Said connections between the physical characteristics (e.g. facial) of the user extracted from the digital image 22 and the specific components of the product are subsequently used by the artificial intelligence module 10 to select among all the possible variants of the individual components of the product, only those more adapted to the specific physical characteristics of a particular user. This allows the user to get personal and automated advice according to his physical characteristics (especially facial) extracted from the digital image 22 obtained by means of acquisition 20.

In particular, in order to make an estimate of the correct dimensional physical characteristics of the user, during the acquisition phase by means of the method 20 it is provided that a specific part of the body of the user is detected together with a reference object (for example, a coin, a credit card, a CD/DVD) that has a pre-defined and known dimensions.

For example, when the image of the face of the user is acquired by method 20, the user places the same reference object in correspondence of his forehead (or another area of the face). Then, the module mapping software 30 recognizes and identifies first the shape of the object within the digital image 22, which is acquired by the method 20, and then, since the size of the object is known, it is able to determine in a reliable way, with reference to said object, the dimensions of all the other measures acquired from the digital image 22. It is intended that other methods for obtaining accurate size are possible including digital measuring or direct input by user of size accurate information.

Suitably, the reference object may be used not only to estimate the size of the features of the face, but also to adjust the color. In particular, as the object is of a predefined and known color, the mapping software module 30 will be able to identify and then appropriately adjust the color of the images. In this way, the module mapping software 30 provides precise magnitudes and colour dimensions relating to the characteristics of the user's face.

Within platform 2, a module 40 is also provided for the display of virtual product 42, which can be obtained by combining the components selected by the user.

In particular, this module 40 is configured to allow an interactive and real-time exploration of said virtual product 42. In particular, in this way, the virtual product 42 can be explored interactively in three dimensions, according to different angles and in different configurations (for example, open or closed), also offering the opportunity to enlarge some details. Additionally, the features and benefits of the product and/or of the individual components may be suitably detected using text and/or media.

Within the platform 2, there is also a software module 50 to perform the virtual testing of the product (virtual try-on). In particular, this software module 50 is configured to augment/superimpose the virtual product 42, for example the eyeglasses, to the digital image 22 of the user's face, which was previously obtained.

In particular, when the virtual product is a pair of glasses, software module 50 of “virtual try-on” is implemented so as to perform in sequence the following steps:
identifying, within the digital image 22 of the user's face, the area within which the virtual glasses 42 must be positioned,
positioning (overlapping) of the virtual glasses 42 on the areas previously identified.

In essence, the module 50 implements a virtual mirror or augmented image functionality allowing the user to try virtually the eyewear created. Preferably, this functionality may be implemented by using augmented reality technique.

The computer platform 2 also comprises a software module 60 for creating and configuring a virtual product 42.

This module 60 is implemented to allow the user to start from an initial version (hereinafter called “zero version”) of the virtual product 42 and then customize it by inserting or making changes to individual virtual components of the same.

The product-configuration software module 60 uses the data 8 and 9 stored within the database. In particular, starting from the initial basic version (“version zero”), the module 60 uses data 9 relating to mechanical coupling/compatibility of the assembly of each component, so as to select and present to the user, within a graphical user interface of a electronic visual display 82, only components, and product variants, that are mechanically coupable/compatible with each other, belonging to the same “core design group” 11.

In addition, the product-configuration software module software 60 works closely with the artificial intelligence software 10 so that, during the selection and creation of the virtual product, variations 33 are suggested and recommended specifically for each user on the basis of the information processed and managed by artificial intelligence module 10.

In particular, variations 33 mainly concern aspects such as the geometric shape, the size, the color and the material of each component; however they can also be extended to other aspects, both visual (for example, decorations or surface finishing) and functional (for example, the assembly mode between the various components or specially functioning lenses or flexible temples, i.e. features that are not easily visible).

For example, the product-configuration software module 60 can be implemented so to guide the user during the creation phase of the product, according to one of the following paths:
starting from a fixed base frame to which are then added custom components compatible with that frame, or
starting from a single component (for example, a pair of lenses) and then build around a frame by choosing and connecting in sequence the various components compatible with that frame, or
starting from a known structure (meaning, frame and lenses) which has a particular characterized design and then change its size and/or certain details of the shape.
starting from a certain design appearance, varying shape but maintaining core aesthetic.

More in detail, inside the graphical user interface of the electronic visual display 82, only one or few variations 33 of the individual components are displayed and suggested to the user as variants for the creation of a next product to view. Alternatively, more variations 33 of the components are displayed inside the graphical user interface; advantageously, the user is presented a matrix of products, linked to suggestions from system, where each variation belong to the same aesthetic design category 13. Moreover, inside the graphical user interface, a visual list of alternative components/component options available for base/core shape may also be presented.

Advantageously, the configuration software module 60 is designed to allow multiple users to collaborate remotely during creation/configuration phase of the virtual product 42. In particular, the participation of the users can be either sequential (i.e. at different times) or simultaneous (i.e. in real time on a shared version of the virtual product 42).

Advantageously, the configuration software module 60 for creating said customized variable virtual product 42 is further configured to process automatically size and/or shape adjustments of any individual components 8 based on the physical features of the user acquired by said means 20.

In particular, the display/visualization software module 40 and the configuration software 60 of the virtual product creation are implemented within hardware infrastructure 1, using a suitable software for 3D modeling and rendering (for example “Adobe 3DS Max”).

The computer-implemented platform 2 also includes a software module 70 for ordering the manufacturing/assembly of the physical product 44 corresponding to the virtual product 42 that was previously created. In particular, the software module 70 is also designed to allow the user to buy the manufactured physical product 44 which corresponds to the virtual product created 42.

Moreover, the computer-implemented platform 2 also comprises a software module that receives the command order from the software module 70 for ordering the physical manufacturing/assembly of the virtual product 42 and is configured to provide correct engineering data for commanding the on-demand physical manufacturing or assembly of the created final version of said virtual product 42.

In particular, the manufacturing of the physical product 44 can occur through the manufacturing of each individual component as specified from the virtual product (for example, with a 3D printing or other on-demand manufacturing). Alternatively, the physical product can be realized through an assembly process of prefabricated components (i.e., obtained by means of industrial production techniques) which correspond to the components of the virtual product 42 created by the user. The manufacturing can also be from a combination of both on-demand manufacturing and the assembly of components already manufactured.

The computer-implemented platform 2 comprises an interface 80, for example, the one of a client device, through which the user interacts, monitors and controls the above-mentioned software modules. In particular, the interface 80 consists of said electronic visual display 82 (for example the PC monitor, etc.) and input pointing device 84 (for example, mouse and touch-screen, etc.) for the easy control and management of the various modules.

The operation of the computer-implemented platform 2 according to the invention, clearly derives from the previous description.

In particular, by the interface 80 of his own device (client), the user logs in and accesses the platform 2 and inside this latter he can navigate in a traditional way.

In particular, by clicking on an external connection (such as web link) that represents a particular product variant, the user will enter the platform 2 following a first path 3 that leads him to see directly (inside the platform itself) a specific virtual product 5 that represents this variant. This external connection can be a visual representation of the product such as a photograph, video or even an interactive 3D representation. It can also be that the user can reach a preferred and specific virtual product 5 by searching and inputting inside the platform 2 one or more data identifying said product. Alternatively, the user can enter the platform 2 following a second path 4 that directs him to the graphical user interface wherein is represented a selection of different product variants 7 from which the user can choose/select by the input pointing device 84 a specific virtual product 5. More in detail, this selection can be displayed in various ways: as a grid of various products, or as a single product image. This grid may contain a diverse range of product variants from different aesthetic design categories 13, or it may contain variants within a defined aesthetic design category 13.

The product variants can appear as simple products or they may appear on the face of a person modeling them. This selection can be simple or random; it can also be intelligent in that it is created to offer a more personal experience for a given user (or type of user). Moreover, this selection may also contain specific and diverse product variants, which serve to allow a better understanding of direct product preferences through the distinctive differences amongst the selection displayed.

In essence, following one of the above paths 3 or 4, the user enters the platform 2 and comes to a virtual product 5, which constitutes the “zero version”, that is the starting point for the subsequent phase of creation. Usually, the “zero version” of the starting product corresponds to a preferred version but not ideal, for the user.

Appropriately, once identified the “zero version” of the virtual product 5, the user can activate the module for display 40 to make a phase of exploration and advanced visualization 17 of the said product. In particular, during phase 17, the user can act on the input pointing device 84 for moving the product in order to view it from a different angles, for zooming in to some of its components and/or details, for activating/displaying other media content (text, audio, video) associated with it (in order to gain a better understanding of the product's specific features and benefits). Advantageously, in the case of eyewear, this exploration phase 17 also includes images that give the user the sensation of seeing through the lens of the glasses themselves, in order to provide a better understand of lens options.

Conveniently, before starting the phase 31 for the personal configuration of the product, the user can make an acquisition phase 25 of the digital image 22 of his face.

In particular, during phase 25, the software module 30 for mapping of the face, appropriately guides the user so that the method 20 can acquire a series of digital images/data sets 22 of the face of the user from different angles, at least one front and two side or vertically from the forehead to the chin. Subsequently, the digital images 22 acquired are presented to the user on the screen 82 of the interface 80, so that the same user can approve or decline, eventually repeating the acquisition. Finally, when the user has approved the digital images acquired 22, he is asked to place the object reference (of known size and color) on the front (or other location of the face) in order to allow the module mapping software 30 to recognize said object, and adjust correspondingly the size and the color of the acquired images 22.

Advantageously, the user may choose to see the specific virtual product variant not only on his or her face, but on the face of others, such as fashion models, friends celebrities etc.

Advantageously, the “zero/starting version” of the virtual product 5, instead of being chosen by the user, can be identified by the module of artificial intelligence 10. In particular, after acquiring one or more digital images 22 of the user's face during acquisition phase 25, the mapping module 30 processes a variety of information 18 relating to the physical compatibility of a given product to a particular person and, on the basis of this information, the artificial intelligence module 10 identifies the “zero version” of the virtual product 5 best suited to the specific characteristics of the user's face.

Then, once identified the “zero version” of the virtual product 5 and after performing any advanced exploration stage 17 of the same product variant (as well as the possible acquisition phase 25 of its digital image 22), the user can move on to the phase 31 for the personal configuration of the product.

In particular, during the configuration phase 31, the module of creation of the virtual product 60 is activated to guide the user interactively in the steps from the “zero version” to a “ideal version” of the virtual product, i.e. the optimal version for the user which is then intended to be physically manufactured by the associated manufacturing/assembly process.

The “ideal version” of the virtual product, generated through the configuration phase 31, may be more or less similar, or completely different, to the starting “zero version”. In general, the variable design concepts used to create a category of product variations enable the user to ‘remain’ within a range of product variations, either within the core group or with similar products from other core groups. But the system is configured to support wide exploration and testing and so the user can venture far away from where he started, but can always come ‘back’ easily to earlier explorations.

During this phase, by acting on the graphical user interface in the visual display 82 by means of the input pointing device 84, the user may choose to view suggestions for similar products (i.e. ones that belong to the same aesthetic design category 13 since they share a significant aesthetic or other design functionality) and/or he may choose to look at alternative versions (i.e. ones that belong to the other aesthetic design categories 13 since they present a distinctively different design, even if they can be connected by a specific preference set).

During the creation of the product 31, within the graphical user interface of the electronic visual display 82, are presented and suggested to the user only (some) variations 33, among said plurality of variations stored in said database 6, that are selected by the software module of artificial intelligence 10.

In particular, said variations 33 are selected by the artificial intelligence module 10 using information 14 related to the preferences and/or information 16 related to user behavior and considering the data about mechanical coupling and/or about the design compatibility between all the variations 33 of the individual components, in order to develop a set of recommendations 32 regarding variations 33 to be made to the “version in progress” 35 of the product.

In essence, recommendations 32 consist of a selection/extraction of some specific variations 33 among all the possible variations of the individual components which are loaded within database 6 and which, once joined together, define different variants of the modular virtual product. In particular, this can be based on the properties of an entire eyewear piece, or the separate components, when a users has indicated preferences. Moreover, it can also be based on similar preferences from other users and/or on a variety of lifestyle preferences. For example, in case of a (male) rock music and a clothing style lover, the suggested changes (which are selected on the basis of such specific profile) may include the use of a dark-rimmed and/or dark lenses, the insertion of metal components on the temples or on the front, etc.

Advantageously, in order to process such 32 suggestions, the artificial intelligence module 10 also uses information 18, obtained by the mapping module 30, and which is related to the physical compatibility of a particular product/component on a specific person.

The phase 31 for personal configuration of the product comprises two additional modes for changing/customizing product. A first additional mode of intervention, through which the user can act by means of the input pointing device 84 for performing variations 33 relating to the color, material and other surface changes. A second additional mode enables the user to act by means of the input pointing device 84 for changing the shape and size of the components on the “version in progress” 35 of the virtual product. In addition to said modes, the user can act by means of the input pointing device 84 for activating more detailed changes, for example the user can perform on said “version in progress” 35 a series of minor changes, such as adding accessories, or functional features (such as polarized lenses) or more detailed customizations (e.g. user's initials engraved). Additionally, these detailed minor changes may be applied to the entire product and/or just on a specific component and view available options for the current version in progress.

More specifically, during the configuration phase 31, the user is presented within the graphical user interface of the electronic visual display 82 with more suggestions 32 relating to variations 33 to be made to the “version in progress” 35. Then, the user can select one or more variations 33, which are then applied to the “version in progress” 35 of the virtual product, which in turn is represented in a “modified version 37”.

For each “modified version” 37 of the suggested virtual product, the user can act by means of the input pointing device 84 for activating:
an advanced and detailed visualization 38 obtained by means of software module display 40, and/or
a virtual test 39 obtained by means of the software module 50 of the “virtual try-on”.

When the “modified version” 37 corresponds to the optimal and desired version of the user, then it is approved and becomes the “final version”; such version will go to the final stage 72 where, by using software module 70, the physical manufacturing/assembly 44 of the customized virtual product 42 that was created in step 31, can be ordered.

Otherwise, the user can cyclically repeat the configuration phase 31 in order to select by means of the input pointing device 84, within the graphical user interface of the electronic visual display 82, new and further variations 33 until gradually, in successive steps, reaches a modified version 37 that corresponds to the “final” version desired by him.

The computer platform, according to the invention, has been described herein in particular by referring to the creation of virtual eyewear, where for eyewear it is intended a pair of vision glasses and/or sunglasses, a pair of goggles or face mask (to be used for skiing, swimming, etc., for example). However, it is understood that this platform can also be used for the creation of other products, such as helmets, headsets, watches, shoes and/or other wearable items or accessories.

From the above, it is clear that the platform, according to this invention, is particularly advantageous as:
it supports the decision-making process, the creation and the purchase of a product by adapting the suggestions given to each user on the basis of a series of information that are acquired in an automatic way,
it allows the user to edit a virtual product with a particularly wide margin of creative freedom,
information about the preferences and behavior of the user or users are used to generate useful tips for creating a customized product, and not for the purchase of predefined standard products,
the virtual image acquisition relative to the user's physical characteristics allows the user himself to make a “virtual try-on” of the virtual product created before proceeding/ordering the physical production of the same, but mainly it advises, during the creation phase of the product, the most suitable changes to his specific physical characteristics. Further, once the virtual image of the user's physical characteristics, such as face, is acquired, it can then be used during the acquisition and/or creation of additional products; and also to carry out a “virtual try-on” of several virtual products together (for example, pairing of a particular model of glasses with a particular model of headphones),
is particularly easy to use, because when starting from an initial and well identified version of the virtual product, the user is allowed to interactively make changes until he reaches the ideal and optimal version for himself.

In particular, the platform, according to the invention, is more advantageous than the already-known platforms, as it appropriately combines an artificial intelligence module, a display module and a module for mapping the user's physical characteristics, in order to support the user during the same stage of creation of a virtual product intended to be then physically realized.

The invention claimed is:

1. A computer implemented platform (2) to create and display a variable virtual product (42) to be realized as a physical product by an associated manufacturing and/or assembly process, comprising:
at least one database (6) wherein there are stored a plurality of variations (33) of individual components (8) which, once joined together, define different variants of said virtual product (42), said database comprising data (9) relating to a mechanical coupling between all a variations (33) of said individual components (8),
a hardware infrastructure (1), wherein there are loaded and run:
a software module of artificial intelligence (10) that, using a series of acquired and/or processed information (12) about a user and considering said data (9) relating to the mechanical coupling between all the variations of said individual components, is configured to select, suggest and present to the user, within a graphical user interface of a electronic visual display (82), only specific optimal variations (33) among said plurality of variations stored in said database (6), and
a software module (60) configured to create said variable virtual product (42), so that, starting from an initial version of said virtual product (42), the user can interactively and cyclically choose, with an input pointing device (84) connected with said electronic visual display (82), at least one of said variations (33) that has been selected and suggested by said software module of artificial intelligence (10) and that is displayed within said graphical user interface, until reaching a final version of said virtual product (42) that is ideal for the user and that corresponds to the eversion intended to be physically realized by said associated manufacturing and/or assembly process; and
an interface (80) through which the user interacts, monitors and controls said software modules (10, 60), said interface comprising said electronic visual display (82) and said input pointing device to control and manage said modules.

2. The computer-implemented platform according to claim 1, wherein:
based on said data (9) relative to the mechanical coupling, said variations (33) are divided into groups (11), each group comprising the variations that are configured to be mechanically coupled together, and
said software module of artificial intelligence (10) is configured to select and suggest the variations to present to the user only among those variations belonging to a same group (11).

3. The computer-implemented platform according to claim 1, wherein said database further comprises data relative to aesthetic design compatibility between the variations (33) of the individual components (8).

4. The computer-implemented platform according to claim 3, wherein:
basing on said data relative to aesthetic design compatibility, said variations (33) are divided into categories (13), each of said categories comprising the variations that share a same aesthetic design style, and
said software module of artificial intelligence (10) is configured to select and suggest the variations to present to the user only among those belonging to the same category (13).

5. The computer-implemented platform according to claim 1, further comprising a system (20) that digitally acquires physical features of the user.

6. The computer-implemented Computer implemented platform according to claim 5, wherein said acquiring system comprises devices provided with optical sensors that produce as output a digital image (22) of the physical features of the user.

7. The computer-implemented platform according to claim 5, wherein said acquiring system comprises wearable devices using smart fabrics.

8. The computer-implemented platform according to claim 6, wherein inside said hardware infrastructure (1) there is also loaded and executed a software module (30) for mapping the digital image (22) relating to the physical features of the user, said module receives as input said digital image (22) and is configured to extract from said digital image a series of values corresponding to various physical features of interest.

9. The computer-implemented platform according to claim 8, wherein said software module (30) for mapping is also configured to define a link between the physical features of the user, extracted from the digital image (22), and aesthetic design categories (13) in which there are subdivided said plurality of variations of the individual components (8) stored in said database (6).

10. The computer-implemented platform according to claim 9, wherein the initial version of said virtual product (42) is selected by the user and/or is automatically chosen by said artificial intelligence module (10) based on the physical features of the user extracted from the digital image (22).

11. The computer-implemented platform according to claim 9, wherein said information based on which said software module of artificial intelligence (10) selects the variations to present and suggest to the user, between the plurality of the variations stored in said database (6), comprises links (18), defined by said mapping software module (30), between the physical features of the user, extracted from the digital image (22), and the aesthetic design categories (13), in which there are subdivided said plurality of variations of the individual components (8) stored in said database (6).

12. The computer-implemented platform according to claim 8, wherein said information based on which said software module of artificial intelligence (10) selects the variations to present and suggest to the user, between the plurality of the variations stored in said database (6), comprises data entered by the user (14), data from other applications (14), and/or data automatically acquired during internet browsing (16).

13. The computer-implemented platform according to claim 8, wherein, inside said hardware infrastructure (1), there is also loaded and run a software module (50) for performing a virtual try-on of the product, and wherein said module is configured to perform in sequence the following steps:
an identification, within said digital image (22) relative to the physical features of the user, of zones on which said virtual product (42) should be placed, and
a positioning of said virtual product (42) on previously identified zones.

14. The computer-implemented platform according to claim 1, further comprising a second software module (70) for commanding and/or ordering a physical manufacturing or assembly of a created final version of said virtual product (42) through said manufacturing or assembly process.

15. The computer-implemented platform according claim 1, wherein, inside the graphical user interface of the electronic visual display (82), the variations (33) of the components, selected by the artificial intelligence software module (10), are displayed and presented as options for creation of a next product to display within the graphical user interface.

16. The computer-implemented platform according to claim 1, wherein the variations (33) of the components, selected by the artificial intelligence software module (10), are displayed within the graphical user interface as a matrix of virtual products presenting one or more of said variations (33).

17. The computer-implemented platform according claim 1, wherein said software module (60) for creating said modular virtual product (42) is further configured to allow the user to act, by way of said input pointing device (84), for changing color, material, surface treatment, shape and size of the components of the virtual product being processed and displayed on the graphic user interface of the electronic visual display (82).

18. The computer-implemented platform (2) according to claim 1, wherein the computer-implemented platform is configured to select, suggest and present to the user, within the graphical user interface of the electronic visual display (82), only certain variations (33) that are ranked/ordered for any given user according to individual preferences of said user.

19. The computer-implemented platform (2) according to claim 1, wherein said variations (33) are divided into categories (13), and wherein each of said categories comprises variations (33) sharing a distinctive and recognizable visual core with a modularly distinctive design feature and/or as an aesthetic design feature.

20. The computer-implemented platform (2) according to claim 1, wherein said software module (60) for designing the virtual product is configured so that the user can alter existing components by changing component size and shape in incremental amounts.

21. The computer-implemented platform (2) according to claim 1, wherein said database (6) comprises data relating to a physical limitation in variability of individual components that are mechanically couplable, thus avoiding an excess of predetermined engineering requirements.

22. The computer-implemented platform (2) according to claim 1, wherein said software module of artificial intelligence (10) is configured to suggest and present to the user at least one product variation (33) that, even if belonging to a different aesthetic design category (13), shares one or more features with a currently processing product.

23. The computer-implemented platform according to claim 14, further comprising a third software module that receives a command order from said software module (70) for commanding and/or ordering the physical manufacturing or assembly of the created final version of said virtual product (42) and is configured to provide to correct engineering data for commanding an on-demand physical manufacturing machine in order to manufacture a final version of said virtual product (42).

24. The computer-implemented platform (2) according claim 5, wherein said software module (60) for creating said variable virtual product (42) is configured to process automatically size and/or shape adjustments of any individual components (8) based on the physical features of the user acquired by said system (20) that digitally acquires physical features of the user.

25. The computer-implemented platform (2) according to claim 1, wherein in said database (6) there are stored a plurality of variations of components which, once joined together, define a virtual pair of eyeglasses (42).

26. The computer-implemented platform (2) according to claim 25, further comprising a system (20) that digitally acquires physical features of the user, wherein said system (20) acquires and produces as output a digital image (22) of the face of a user.
